(19) United States
(12) Patent Application Publication
(10) Pub. No.: US 2007/0229670 A1
(43) Pub. Date: Oct. 4, 2007

(54) Information apparatus system, electronic camera for use therein, and method for controlling information processing apparatus from the electronic camera

(76) Inventor: Takumi Soga, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/726,036

(22) Filed: Mar. 19, 2007

(30) Foreign Application Priority Data
Mar. 31, 2006 (JP) 2006-100168

(51) Int. Cl. H04N 5/232

(52) U.S. Cl. 348/211.2

(57) ABSTRACT

An information apparatus system includes an access point which sets a wireless network, a first information processing apparatus having an image output section, and a second information processing apparatus having an image pickup section is disclosed. In the information apparatus system, the first information processing apparatus output information necessary to establish communication on an image output section, the second information processing apparatus captures the visualized information with the image pickup section and establishes communication between the first information processing apparatus and the second information processing apparatus. The second information processing apparatus sends a control command to the first information processing apparatus.

### CROSS REFERENCES TO RELATED APPLICATION

This application is based upon and claims the benefit of priority from prior Japanese Patent Application No. 2006-100168, filed on Mar. 31, 2006, the entire contents of which are incorporated herein by reference.

### BACKGROUND OF THE INVENTION

1. Field of the Invention

The present invention relates to an information apparatus system which wirelessly connects a plurality of information apparatuses using a wireless communication protocol including transmission and reception of unique network information, an electronic camera for use therein, and a method for controlling information processing apparatus from the electronic camera.

2. Description of the Related Art

Recently, it becomes popular to use an information apparatus system that employs a wireless communication protocol including transmission and reception of unique network information, such as IEEE 802.11x, to construct a WLAN (Wireless Local Area Network), which is a wireless network, and wirelessly connect a plurality of information apparatuses.

For example, as shown in FIG. 17, such an information apparatus system constructs a WLAN 103 with a wireless communication protocol like IEEE 802.11x using an access point 100. A plurality of information apparatuses present in the wirelessly communicatable range of the WLAN 103, e.g., personal computers (hereinafter “PCs”) 101, 102, are connected to the access point 100 through wireless communication.

The access point 100 assigns a unique IP address to each of the PCs 101, 102 to be connected through wireless communication, identifies the PC 101, 102 based on the IP address, and mediates information transmission between the PCs 101 and 102. Recently, a digital still camera (hereinafter “DSC”) 104 having an image pickup section is provided with a wireless communication section so that the DSC 104 is connectable to the WLAN 103.

Because the WLAN 103 is constructed through wireless communication, if another WLAN 153 having, for example, a PC 151 connected thereto is constructed near the WLAN 103 as shown in FIG. 18, there may be an area where the wireless communication ranges of the WLAN 103 and the WLAN 153 overlap. If the DSC 104 is positioned in the overlapping area, for example, the DSC 104 becomes connectable to the WLAN 103 and the WLAN 153.

To connect the DSC 104 to a desired WLAN, the access point 100 of the WLAN 103 and an access point 150 of the WLAN 153 set SSIDs (Service Set Identifiers) or ESSIDs (Extended Service Set Identifiers) to identify wireless networks the WLANs 103 and 153 providing. FIG. 18 shows an example where the SSID of the WLAN 103 is set to “ABCD”, and the SSID of the WLAN 153 is set to “abcd”. The DSC 104 can connect to a desired WLAN by discriminating the SSID.

For security of data to be transferred, an encryption key called WEP (Wired Equivalent Privacy: 64-bit WEP key or 128-bit WEP key) can be set in each of the WLANs.

Apparently, it is necessary to set configuration information as setting information, such as the IP address of each apparatus, the SSID of a wireless network and a WEP key, to connect an information apparatus to a WLAN.

In general, to set the setting information, the PC 101 starts dedicated setting utility software and allows to set the setting information using a keyboard or the like.

On the other hand, the DSC 104, as shown in FIG. 19, may display a string of characters on a liquid crystal display (LCD) monitor 104c provided at the back of it, allow the user to move a pointer 173 using an arrow pad 161, and displays information to be set in a designated area for designating, for example, an SSID. And the DSC 104 may allow the user to set the setting information using a SET button 162.

Alternatively, as shown in FIG. 20, the DSC 104 may have touch switches 180 provided on the LCD monitor 104c, display a keyboard 181 on the LCD monitor 104c. The DSC 104 may allow the user to operate the keyboard 181 using the touch switches 180 and display the setting information, e.g., an SSID, in the designated area 104c to set the setting information.

There may be a case where as shown in FIG. 21, dedicated setting utility software 200 is started on the PC 101, and the setting information is set to the DSC 104 via a USB cable using the setting utility software 200. There may be another case where as shown in FIG. 22, the setting information is set to the DSC 104 via a memory card 201 using the setting utility software 200.

When setting information is set using the DSC 104 alone, it is necessary to use the LCD monitor 104c, which is required to be designed compact to be provided at the back of the DSC 104. The operation of setting the setting information on such a small LCD monitor 104c may be troublesome. Setting the setting information to the DSC 104 using the setting utility software 200 on the PC 101 requires the USB cable or the memory card 201.

On the other hand, Japanese Patent Laid-Open No. 2003-143457, for example, discloses an information apparatus system that displays specific information on a PC as an information apparatus, and allows a user to capture the specific information with a DSC, and identifies the specific information through an image recognition process.

### BRIEF SUMMARY OF THE INVENTION

The present invention provides an information apparatus system having an access point that realizes a wireless network, a first information processing apparatus having an image output section, and a second information processing apparatus having an image pickup section. In the information apparatus system, the first information processing apparatus displays information necessary to establish the connection on its image output section, the second information processing apparatus captures the visualized information with the image pickup section, and establishes a communication between the first information processing apparatus and the second information processing apparatus. Then, the second information processing apparatus sends a control command to the first information processing apparatus.

An example of the information necessary to establish the connection is unique network information or identification information. The identification information is, for example, assigned to each of the information processing apparatus by the access point.

The first information processing apparatus can be, for example, a computer. The second information processing apparatus can be, for example, an electronic camera.

As an example of the control can be a launching a program in the first information processing apparatus.

An example of the information apparatus system according to the present invention comprises an access point that sets a wireless network according to a wireless communication protocol including unique network information; a first information processing apparatus having a first wireless communication section wirelessly communicatable with the access point over the wireless network by the wireless communication protocol; a second information processing apparatus having a second wireless communication section which is wirelessly communicatable with the access point over the wireless network by the wireless communication protocol, and an image pickup section which images a subject, wherein the access point assigns identification information to identify an information processing apparatus to be connected to the wireless network to each of the first and second information processing apparatuses, the first information processing apparatus has an image output control section which generates an information image including the unique network information and the identification information, and sends the information image to an image output section, the second information processing apparatus has an information analyzing section which performs image processing on the information image, output to the image output section in the first information processing apparatus and captured by the image pickup section, to analyze the unique network information and the identification information of the first information processing apparatus included in the unique network information, and a command output section which sends a control command to the first information processing apparatus via the access point based on the unique network information and the identification information of the first information processing apparatus analyzed by the information analyzing section.

In a case where an electronic camera is used as the second information processing apparatus, the present invention can be understood as an invention of an electronic camera, and a method for controlling an information processing apparatus from the electronic camera.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a structural diagram illustrating the configuration of an information apparatus system according to a first embodiment of the present invention;

FIG. 2 is a diagram showing the front appearance of a DSC in FIG. 1;

FIG. 3 is a diagram showing the rear appearance of the DSC in FIG. 1;

FIG. 4 is a block diagram showing the configuration of the DSC in FIG. 1;

FIG. 5 is a functional block diagram showing the functional structure of a control circuit in FIG. 4;

FIG. 6 is a block diagram showing the configuration of a PC in FIG. 1;

FIG. 7 is a functional block diagram showing the functional structure of a control circuit in FIG. 6;

FIG. 8 is a flowchart illustrating the flow of processes when the wireless network communication of the PC in FIG. 6 starts;

FIG. 9 is a diagram for explaining the processes in FIG. 8;

FIG. 10 is a flowchart illustrating the flow of processes when the wireless network communication of the DSC in FIG. 4 starts;

FIG. 11 is a diagram for explaining the processes in FIG. 10;

FIG. 12 is a flowchart illustrating the flow of processes of the DSC in a wireless communication mode in FIG. 10;

FIG. 13 is a flowchart illustrating the flow of processes of the PC in the wireless communication mode in FIG. 10;

FIG. 14 is a first diagram for explaining an application program corresponding to key switch information which is invoked in a process in FIG. 13;

FIG. 15 is a second diagram for explaining the application program corresponding to key switch information which is invoked in the process in FIG. 13;

FIG. 16 is a third diagram for explaining the application program corresponding to key switch information which is invoked in the process in FIG. 13;

FIG. 17 is a first diagram for explaining a conventional wireless network;

FIG. 18 is a second diagram for explaining the conventional wireless network;

FIG. 19 is a first diagram for explaining a method of setting network information with a conventional DSC;

FIG. 20 is a second diagram for explaining the method of setting network information with the conventional DSC;

FIG. 21 is a third diagram for explaining the method of setting network information with the conventional DSC; and

FIG. 22 is a fourth diagram for explaining the method of setting network information with the conventional DSC.

### DETAILED DESCRIPTION OF THE PREFERRED EMBODIMENT

A preferred embodiment of the invention is described below with reference to the accompanying drawings.

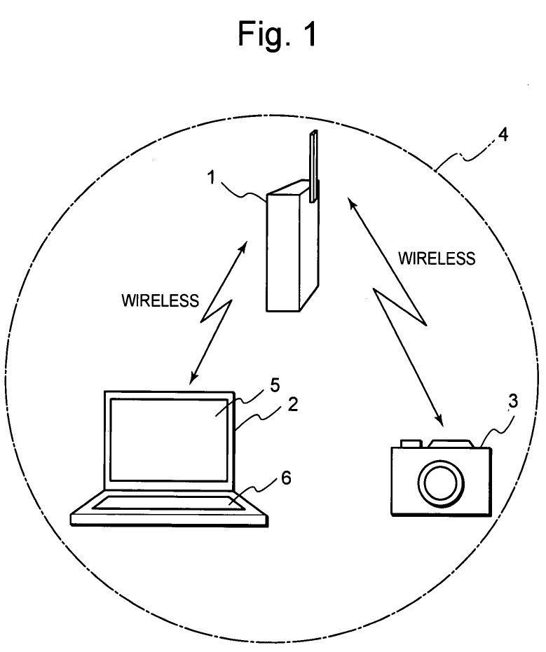

An information apparatus system according to the embodiment, as shown in FIG. 1, has an access point 1, a PC 2 which is a first information apparatus, and a DSC 3 which is a second information apparatus. The access point 1 provides a WLAN 4 having an SSID which is a predetermined wireless network name, and wirelessly connects the PC 2 and the DSC 3 located within the wireless communication range of the WLAN 4 using a predetermined wireless communication protocol (e.g., IEEE 802.11x). The access point 1 respectively assigns unique IP addresses to the PC2 and the DSC 3 using a DHCP (Dynamic Host Configuration Protocol) function. Further, the access point 1 achieves the data security of the WLAN 4 with the use of an encryption key, e.g., a 128-bit WEP key.

According to the embodiment, the ON/OFF setting of the DHCP function of the access point 1 and the setting of the 128-bit WEP key can be executed using the PC 2.

In the embodiment, information including a 128-bit WEP key and an SSID is presented as an example of unique network information. An IP address is presented as an example of identification information.

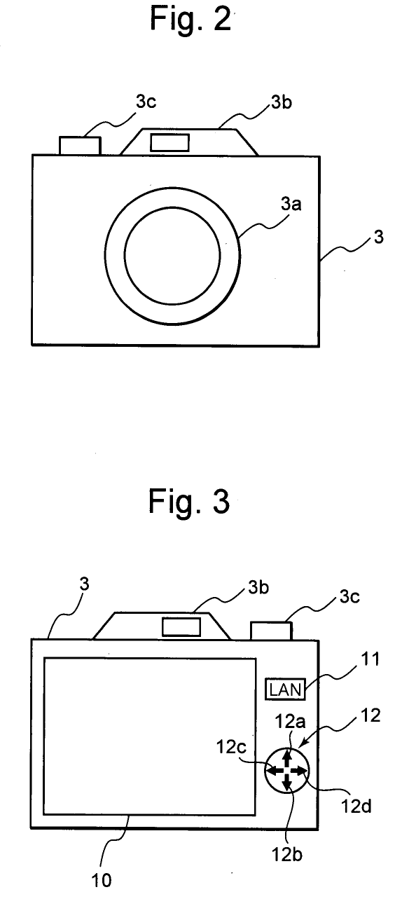

As shown in FIG. 2, the DSC 3 has a lens section 3a on the front side, and a viewfinder section 3b and a shutter 3c at the top portion. A subject image is input to the lens section 3a. As shown in FIG. 3, the DSC 3 further has, on the back side, an LCD monitor section 10, a mode changeover switch 11, and an arrow pad 12. The LCD monitor section 10 displays digital image data of an imaged subject and various menu screens. The mode changeover switch 11 switches the mode of the DSC 3 between a normal shooting mode and a WLAN communication mode. The arrow pad 12 serves as an operation key to operate various menu screens on the LCD monitor section 10 in normal shooting mode, and serves as a command key to set a control command to the PC 2 in WLAN communication mode. The arrow pad 12 includes an UP key 12a, a DOWN key 12b, a LEFT key 12c and a RIGHT key 12d.

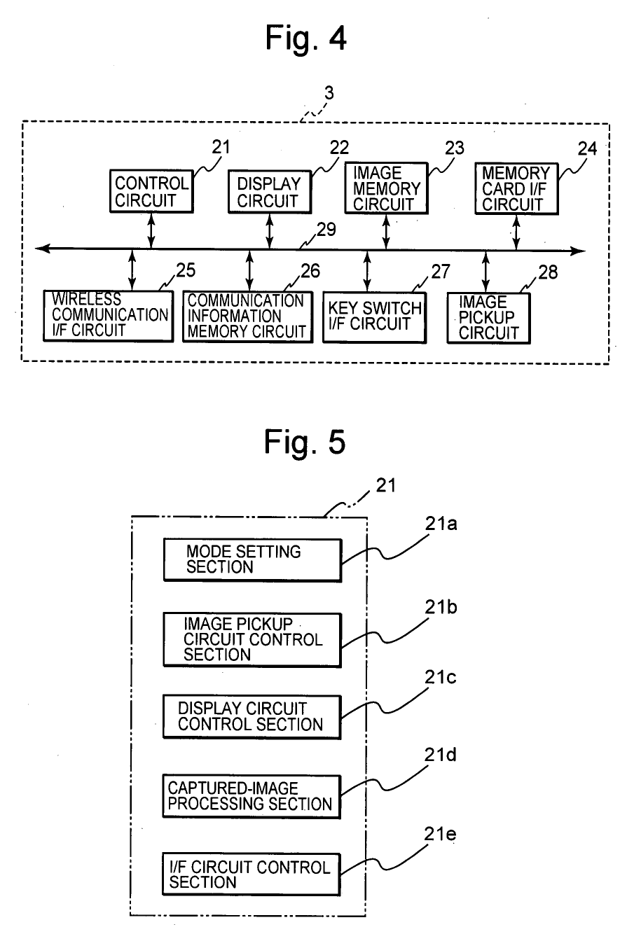

As shown in FIG. 4, the DSC 3 includes a control circuit 21, a display circuit 22, a image memory circuit 23, a memory card interface (I/F) circuit 24, a wireless communication I/F circuit 25, a communication information memory circuit 26, a key switch I/F circuit 27, and an image pickup circuit 28. Those circuits are connected through an internal bus 29.

The control circuit 21 controls each of the circuits and executes various processes. The control circuit 21 is realized with, for example, a CPU. Specifically, the control circuit 21 has a mode setting section 21a, an image pickup circuit control section 21b, a display circuit control section 21c, a captured-image processing section 21d, and an I/F circuit control section 21e. While those functional sections can be realized by independent circuit units, they can be realized by individual modules of a program which is executed by, for example, the CPU.

The mode setting section 21a sets the mode according to the setting of the mode changeover switch 11. The image pickup circuit control section 21b controls the image pickup circuit 28. The display circuit control section 21c controls the display circuit 22.

The captured-image processing section 21d functions as an information analyzing section. The captured-image processing section 21d performs various image processes on digital image data in normal shooting mode and performs an image recognition processes on digital image data in WLAN communication mode to thereby acquire an SSID, a 128-bit WEP key and the IP address of the PC 2.

The I/F circuit control section 21e functions as a command output section. The I/F circuit control section 21e controls various I/F circuits, such as the memory card I/F circuit 24, the wireless communication I/F circuit 25 and the key switch I/F circuit 27.

The display circuit 22 generates display images of digital image data, various menu screens and the like, and displays the display images. The memory card I/F circuit 24 is an interface which transmits and receives digital image data and various kinds of data to and from a memory card (not shown).

The wireless communication I/F circuit 25 is an interface which wirelessly communicates with the WLAN 4. The wireless communication I/F circuit 25 functions as a second wireless communication section. The communication information memory circuit 26 stores communication setting information, such as an SSID, a 128-bit WEP key, a local IP address and the IP address of a corresponding apparatus, which is needed in communication with the WLAN 4.

The key switch I/F circuit 27 is an interface to input the operational statuses of the mode changeover switch 11 and the arrow pad 12. The image pickup circuit 28 functions as an image pickup section. The image pickup circuit 28 drives an image pickup device (not shown), such as a CCD sensor or a CMOS sensor, which has an imaging plane at the image forming position of the lens section 3a to convert a subject image to digital image data, and stores the digital image data into the image memory circuit 23.

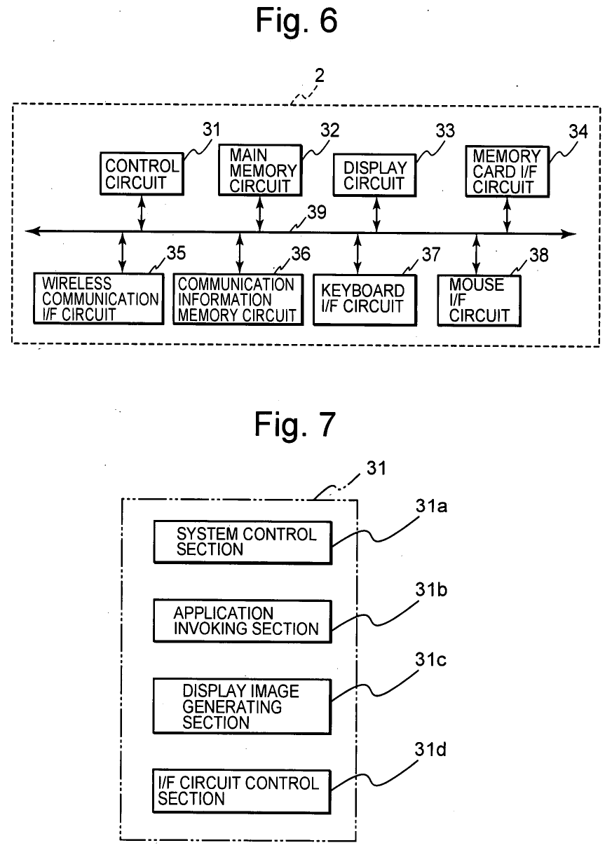

As shown in FIG. 6, the PC 2 includes a control circuit 31, a main memory circuit 32, a display circuit 33, a memory card I/F circuit 34, a wireless communication I/F circuit 35, a communication information memory circuit 36, a keyboard I/F circuit 37, and a mouse I/F circuit 38. Those individual circuits are connected through an internal bus 39.

The control circuit 31 controls the individual circuits and executes various processes using the main memory circuit 32. As shown in FIG. 7, the control circuit 31 has a system control section 31a, an application invoking section 31b, a display image generating section 31c, and an I/F circuit control section 31d.

The system control section 31a controls an operating system. The application invoking section 31b invokes various kinds of application software. The display image generating section 31c generates display images of window screens of various kinds of application software, a folder image and the like. The I/F circuit control section 31d controls various I/F circuits, such as the memory card I/F circuit 34, the wireless communication I/F circuit 35, the keyboard I/F circuit 37 and the mouse I/F circuit 38.

The display circuit 33 functions an image output control section. The display circuit 33 generates display images of window screens of various kinds of application software, a folder image and the like, and an information code image to be described later, and displays the display images and the information code image on an LCD monitor 5 (see FIG. 1) which is a display monitor serving as an image output section.

The memory card I/F circuit 34 is an interface which transmits and receives digital image data and various kinds of data to and from a memory card (not shown). The wireless communication I/F circuit 35 functions as a first wireless communication section. The wireless communication I/F circuit 35 is an interface which wirelessly communicates with the WLAN 4.

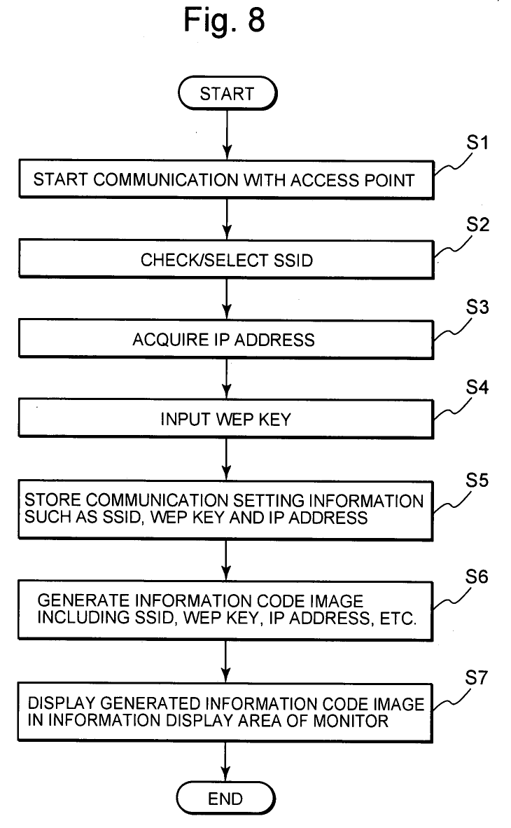

The communication information memory circuit 36 stores communication setting information, such as an SSID, a 128-bit WEP key, a local IP address and the IP address of a corresponding apparatus, which is needed in communication with the WLAN 4. The keyboard I/F circuit 37 is an interface to input the operational status of a keyboard 6 (see FIG. 1). The mouse I/F circuit 38 is an interface to input the operational status of a mouse (not shown). The operation of the embodiment with the above-described configuration will now be explained referring to FIGS. 8 to 16.

As shown in FIG. 8, first, the control circuit 31 of the PC 2 initiates wireless communication with the access point 1 in step S1. In step S2, the control circuit 31 checks/selects the SSID of the WLAN 4 of the access point 1 via the wireless communication I/F circuit 35 using the I/F circuit control section 31d. In step S3, the control circuit 31 acquires a local IP address from the access point 1 using the I/F circuit control section 31d. In step S4, the control circuit 31 accepts a 128-bit WEP key from the keyboard 6 using the I/F circuit control section 31d, and sets the 128-bit WEP key in the access point 1.

In step S5, the control circuit 31 of the PC 2 stores communication setting information, such as the SSID, the local IP address and the 128-bit WEP key, into the communication information memory circuit 36.

In next step S6, the control circuit 31 of the PC 2 generates an information code image including the communication setting information, such as the SSID, the local IP address and the 128-bit WEP key. In step S7, the control circuit 31 of the PC 2 displays the generated information code image in an information display area on the LCD monitor 5.

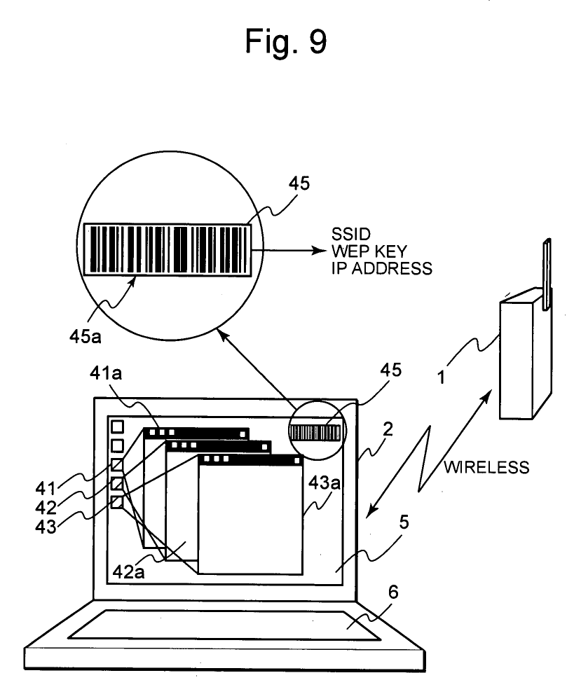

FIG. 9 shows the state of the LCD monitor 5 showing an information code image 45a in an information display area 45 when a plurality of applications are invoked on the PC 2. For example, icons 41, 42 and 43 of first to third applications are invoked, and the information code image 45a is displayed in a predetermined information display area 45 on the LCD monitor 5 on which windows 41a, 42a and 43a of the first to third applications are opened. The information code image 45a includes a barcode image and includes communication setting information, such as the SSID, the local IP address and the 128-bit WEP key.

The information code image 45a is not limited to a barcode image. For example, the information code image 45a can be a two-dimensional code image (e.g., a QR (Quick Response) code image) or a character string image.

A description will now be given of the operation of the DSC 3 when the information code image 45a is displayed on the LCD monitor 5 with wireless communication between the PC 2 and the access point 1 being established.

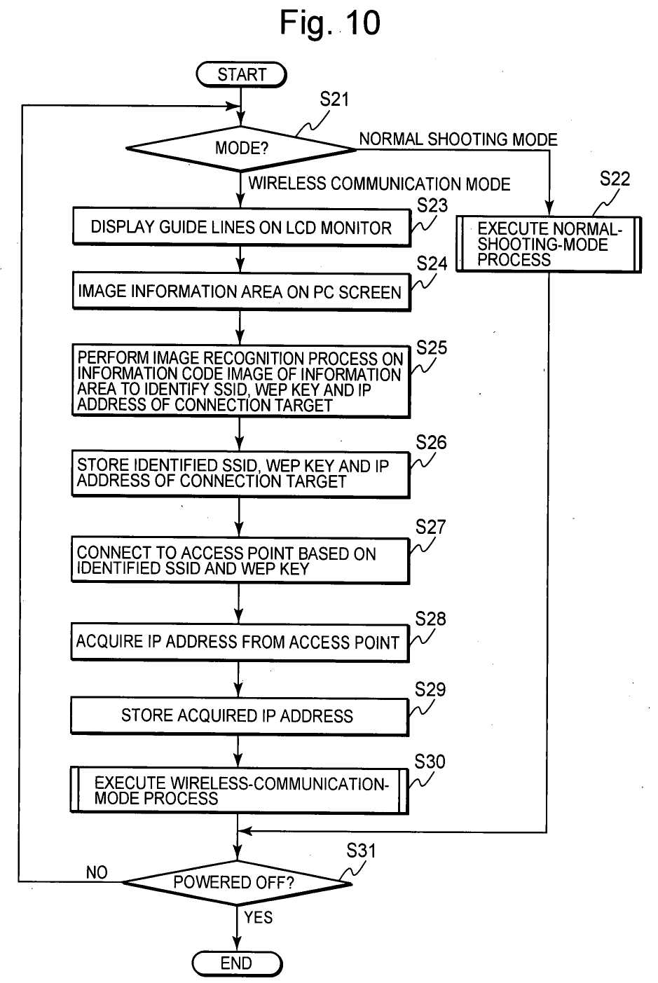

As shown in FIG. 10, the control circuit 21 of the DSC 3 determines in step S21 whether or not the mode is set to the normal shooting mode or the wireless communication mode based on the status of the mode changeover switch 11 using the mode setting section 21a. The control circuit 21 executes a normal-shooting-mode process when the mode is the normal shooting mode, or goes to step S23 when the mode is the wireless communication mode.

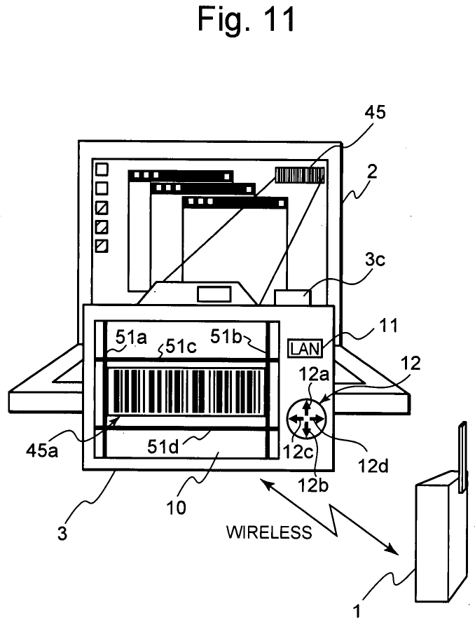

In step S23, the control circuit 21 of the DSC 3 displays guide lines 51a to 51d on the LCD monitor section 10 as shown in FIG. 11 using the display circuit control section 21c. When a user fits the information code image 45a within space defined by the guide lines 51a to 51d and presses the shutter 3c, the control circuit 21 of the DSC 3 captures the information code image 45a in the information display area 45 using the image pickup circuit control section 21b in step S24.

Then, in step S25, the control circuit 21 of the DSC 3 performs an image recognition process of the captured information code image 45a to identify the SSID, the IP address of the PC2 to connect and the 128-bit WEP key using the captured-image processing section 21d.

In next step S26, the control circuit 21 of the DSC 3 stores the identified SSID, IP address of the PC2 to connect and 128-bit WEP key into the communication information memory circuit 26.

In next step S27, the control circuit 21 of the DSC 3 initiates wireless communication with the access point 1 via the wireless communication I/F circuit 25 based on the identified SSID and 128-bit WEP key using the I/F circuit control section 21e.

In step S28, the control circuit 21 of the DSC 3 acquires the local IP address from the access point 1 via the wireless communication I/F circuit 25 using the I/F circuit control section 21e. In step S29, the control circuit 21 of the DSC 3 stores the acquired local IP address in the communication information memory circuit 26.

In step S30, the control circuit 21 of the DSC 3 executes a wireless-communication-mode process to be described later, and repeats the sequence of processes of step S21 to step S30 until the DSC 3 is powered off in step S31.

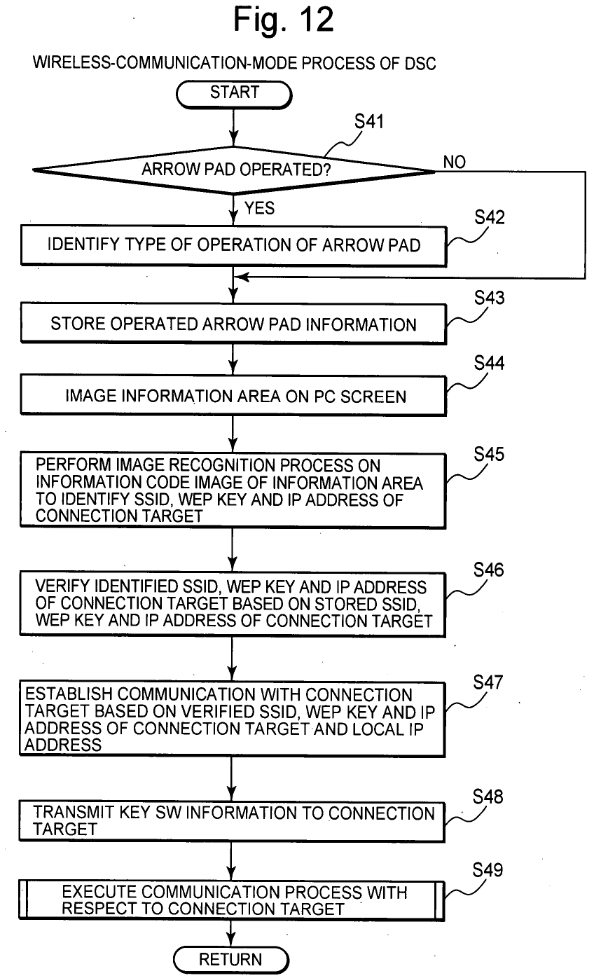

The wireless-communication-mode process of the DSC 3 in step S30 will be described below referring to FIG. 12.

In the wireless-communication-mode process of the DSC 3, as shown in FIG. 12, the control circuit 21 of the DSC 3 detects the operational status of the arrow pad 12 via the key switch I/F circuit 27 using the I/F circuit control section 21e and determines whether or not the arrow pad 12 is operated in step S41. When the arrow pad 12 is operated, the control circuit 21 goes to step S42. When the arrow pad 12 is not operated, the control circuit 21 goes to step S43.

In step S42, the control circuit 21 of the DSC 3 identifies the type of the operated key of the arrow pad 12. Then, the control circuit 21 of the DSC 3 stores key switch (SW) information indicating the type of the operated key of the arrow pad 12, as a control command, in the communication information memory circuit 26, and then goes to step S44.

When the arrow pad 12 is not operated, however, the control circuit 21 of the DSC 3 stores key SW information “No key SW” in the communication information memory circuit 26 in step S43.

In step S44, the control circuit 21 of the DSC 3 displays the guide lines 51a to 51d on the LCD monitor section 10 using the display circuit control section 21c. When the user fits the information code image 45a within space defined by the guide lines 51a to 51d and presses the shutter 3c, the control circuit 21 of the DSC 3 captures the information code image 45a in the information display area 45 using the image pickup circuit control section 21b.

Then, in step S45, the control circuit 21 of the DSC 3 performs an image recognition process of the captured information code image 45a to identify the SSID, the IP address of the PC2 to connect and the 128-bit WEP key using the captured-image processing section 21d.

In next step S46, the control circuit 21 of the DSC 3 collates the identified SSID, IP address of the PC2 to connect and 128-bit WEP key into the communication information memory circuit 26 with the SSID, IP address of the PC2 to connect and 128-bit WEP key all stored into the communication information memory circuit 26 to thereby verify the identified SSID, IP address of the PC2 to connect and 128-bit WEP key.

In next step S47, the control circuit 21 of the DSC 3 establishes wireless communication with the PC 2 to connect via the access point 1 based on the verified SSID and 128-bit WEP key and the local IP address.

In next step S48, the information control circuit 21 of the DSC 3 transmits the key SW information that is a control command stored in the communication information memory circuit 26 to the PC 2 via the wireless communication I/F circuit 25 using the I/F circuit control section 21e.

In step S49, the control circuit 21 of the DSC 3 executes a communication process, which is described in detail later, with respect (to the PC 2 based on the key SW information, and then terminates the process.

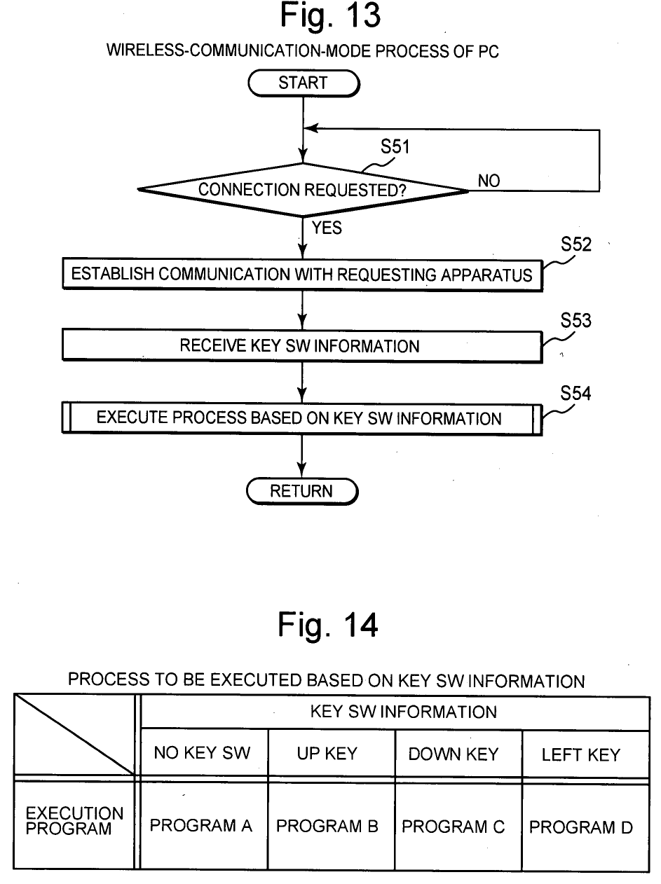

A description will now be given of the wireless-communication-mode process of the PC 2 in step S30 referring to FIG. 13.

In the wireless-communication-mode process of the PC 2, as shown in FIG. 13, the control circuit 31 of the PC 2 stands by for a connection request from the DSC 3 via the wireless communication I/F circuit 35 using the I/F circuit control section 31d in step S51. When there is a connection request from the DSC 3, the control circuit 31 goes to step S52.

In step S52, the control circuit 31 of the PC 2 establishes wireless communication with the DSC 3 via the wireless communication I/F circuit 35 using the I/F circuit control section 31d. When the wireless communication is established, the control circuit 31 of the PC 2 receives the key SW information from the DSC 3 via the wireless communication I/F circuit 35 using the I/F circuit control section 31d in step S53.

Then, the control circuit 31 of the PC 2 executes a communication process based on the key SW information in step S54, and then terminates the process.

As a communication process based on the key SW information, the control circuit 31 of the PC 2 invokes an application program corresponding to the key SW information using the application invoking section 31b.

FIG. 14 shows one example of the application programs corresponding to key switch information, which are to be invoked by the control circuit 31. For example,

when key SW information=“No key SW”, a program A is invoked,

when key SW information=UP key 12a, a program B is invoked,

when key SW information=DOWN key 12b, a program C is invoked, and

when key SW information=LEFT key 12c, a program D is invoked.

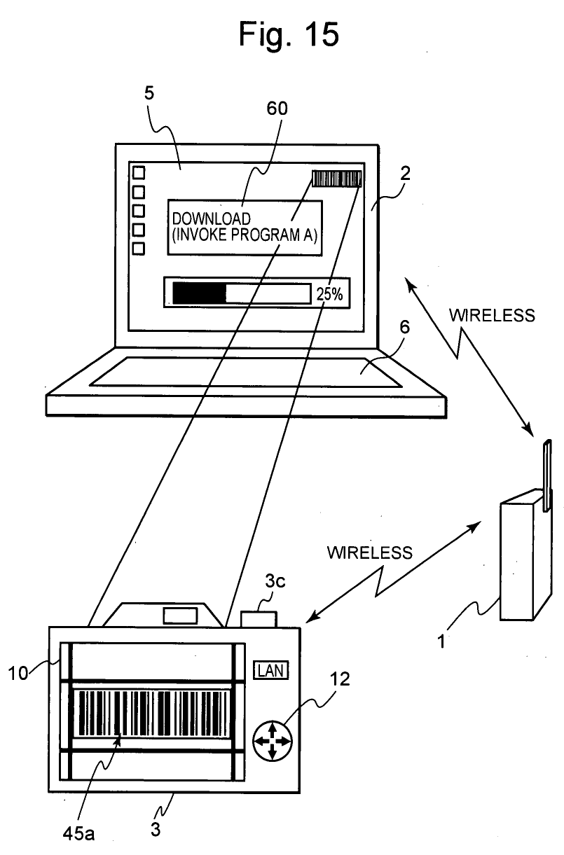

Specifically, as shown in FIG. 15, when the shutter 3c is pressed without operating the arrow pad 12 and the DSC 3 captures the information code image 45a, information where key SW information=“No key SW” is transmitted to the PC 2 from the DSC 3 via the access point 1. Based on the information indicating key SW information=“No key SW”, the PC 2 invokes the program A, for example, a download program, and starts downloading image data stored in the image memory circuit 23 of the DSC 3.

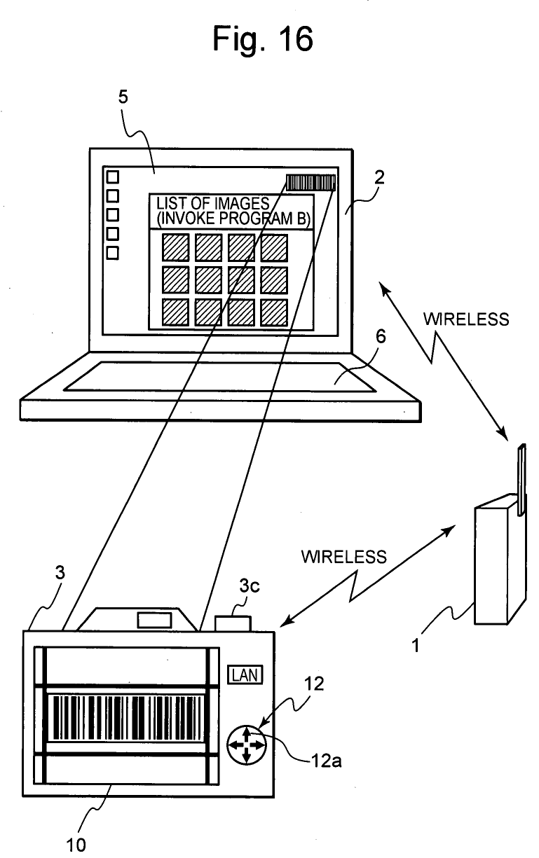

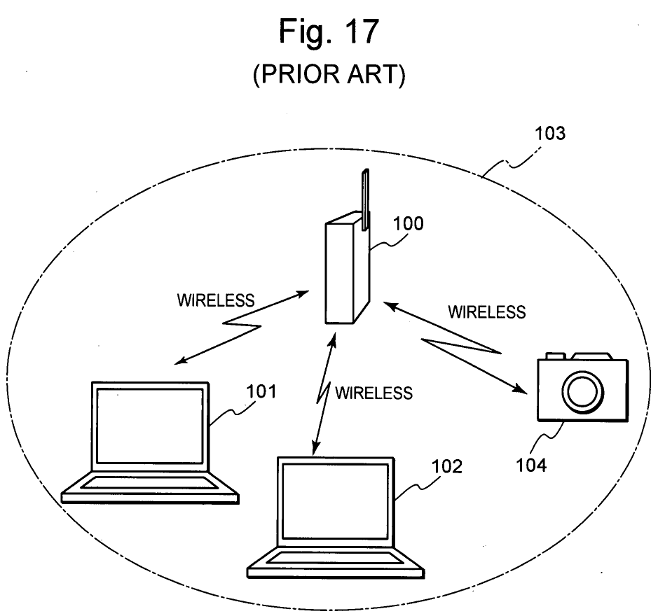

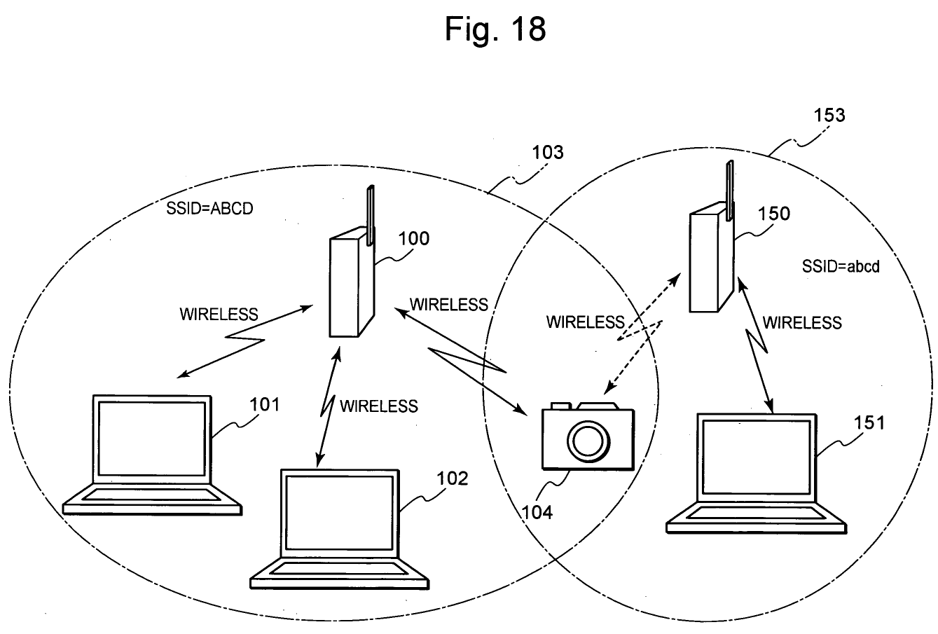

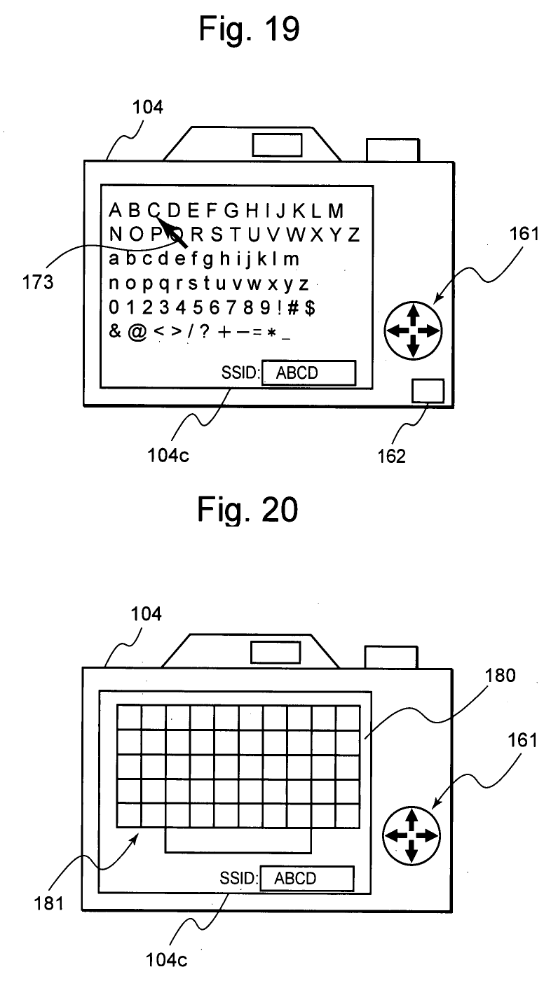

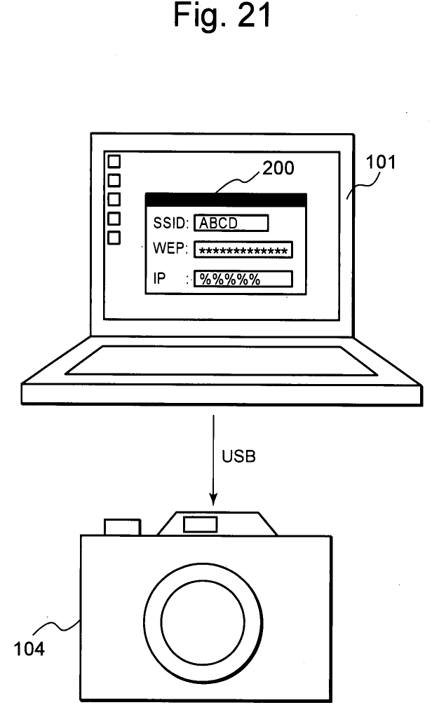

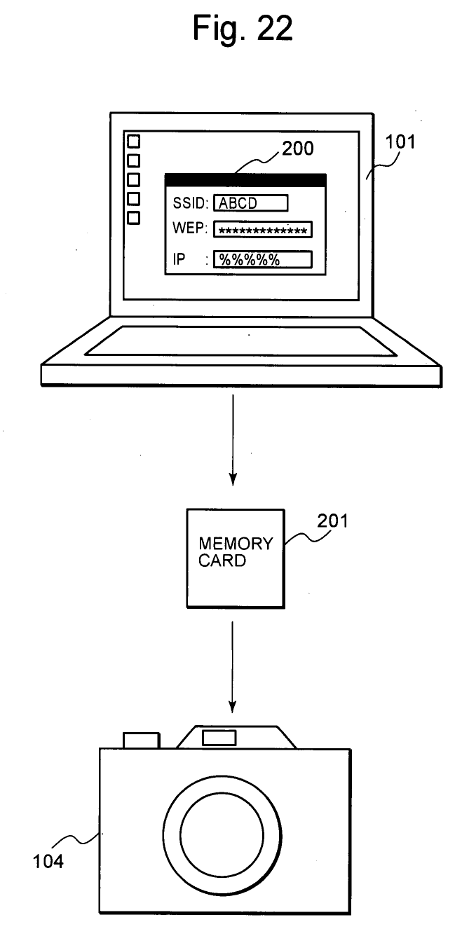

When the UP key 12a of the arrow pad 12 is operated as shown in FIG. 16, and the shutter 3c is pressed so that the DSC 3 captures the information code image 45a, information indicating key SW information=UP key 12a is transmitted to the PC 2 from the DSC 3 via the access point 1. Based on the information indicating key SW information=UP key 12a, the PC 2 invokes the program B, for example, an image viewer program, and displays a list of image data stored in the image memory circuit 23 of the DSC 3, as a file or a thumbnail, on the LCD monitor 5.

When the DOWN key 12b of the arrow pad 12 is operated (not shown) and the shutter 3c is pressed so that the DSC 3 captures the information code image 45a, information indicating key SW information=DOWN key 12b is transmitted to the PC 2 from the DSC 3 via the access point 1. Based on the information indicating key SW information=DOWN key 12b, the PC 2 invokes the program C, for example, a file manager program.

Likewise, when the LEFT key 12c of the arrow pad 12 is operated (not shown) and the shutter 3c is pressed so that the DSC 3 captures the information code image 45a, information indicating key SW information=LEFT key 12c is transmitted to the PC 2 from the DSC 3 via the access point 1. Based on the information indicating key SW information=LEFT key 12c, the PC 2 invokes the program D, for example, a control program (remote control program).

According to the embodiment, as described above, as the DSC 3 captures the information code image 45a displayed on the PC 2, the DSC 3 can acquire the setting information of a WLAN and the IP address of an apparatus to connect, and can easily establish wireless communication with the apparatus to connect. Further, the DSC 3 can allow the PC 2 to easily invoke a desired program by a simple operation of operating the arrow pad 12 and capturing the information code image 45a.

Because the DSC 3 can invoke application software on a PC, it is unnecessary to previously invoke application software on the PC.

This makes it possible for the DSC 3 to easily connect to a wireless network and allow an information apparatus connected to the wireless network to easily invoke desired application software.

The guide lines 51a to 51d are displayed on the LCD monitor section 10 of the DSC 3 at the time the DSC 3 captures the information code image 45a, so that as the user fits the information code image 45a within space defined by the guide lines 51a to 51d and presses the shutter 3c, the information code image 45a can always be captured with a stable resolution, thus ensuring recognition of information through image processing.

Although the image output section is realized as the LCD monitor 5 in the embodiment, it is not restrictive. For example, it is possible that a printer I/F section is provided in the PC 2, though not illustrated, so that a printer connected to the printer I/F section becomes the image output control section.

In general, an image output to a printer has a higher contrast than the contrast of an image displayed on a display monitor, such as the LCD monitor 5, so that with the image output section being a printer, the reliability of image analysis of the information code image 45a captured by the DSC 3 can be enhanced.

The present invention is not limited to the above-described embodiment, and can be modified and changed in various forms without departing from the scope of the invention.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An information apparatus system comprising:
an access point that sets a wireless network according to a wireless communication protocol including unique network information;
a first information processing apparatus having a first wireless communication section wirelessly communicatable with the access point over the wireless network using the wireless communication protocol;
a second information processing apparatus having a second wireless communication section which is wirelessly communicatable with the access point over the wireless network using the wireless communication protocol, and an image pickup section for imaging a subject,
wherein the access point assigns identification information for identifying an information processing apparatus to be connected to the wireless network to each of the first and second information processing apparatuses,
the first information processing apparatus has an image output control section which generates an information image including the unique network information and the identification information, and makes an image output section output the information image, and
the second information processing apparatus has an information analyzing section which performs image processing on the information image output to the image output section of the first information processing apparatus and captured by the image pickup section, to analyze the unique network information and the identification information of the first information processing apparatus included in the unique network information, and a command output section which sends a control command to the first information processing apparatus via the access point using the wireless communication protocol based on the unique network information and the identification information of the first information processing apparatus analyzed by the information analyzing section.

2. The information apparatus system according to claim 1, wherein the second information processing apparatus displays a guide line to designate an imaging area for the information image to be captured by the image pickup section.

3. The information apparatus system according to claim 1, wherein the second information processing apparatus has a mode setting section which sets a mode by switching a plurality of modes including at least a normal shooting mode to image the subject and a wireless communication mode to capture the information image and output the control command.

4. The information apparatus system according to claim 1, wherein the image output section is one of a display monitor and a printer.

5. An electronic camera communicatable with an information apparatus system wherein
the information apparatus system comprising an access point that sets a wireless network according to a wireless communication protocol including unique network information, and assigns identification information to identify an information processing apparatus to be connected to the wireless network to each information processing apparatus,
the information apparatus further comprising an information processing apparatus having a first wireless communication section wirelessly communicatable with the access point over the wireless network using the wireless communication protocol, and an image output control section which generates an information image including the unique network information and the identification information, and makes an image output section output the information image,
the electronic camera comprising a second wireless communication section wirelessly communicatable with the access point over the wireless network by the wireless communication protocol; and
the electronic camera further comprising an image pickup section which captures the information image output on the image output section in the information processing apparatus, the electronic camera displaying a guide line to designate an imaging area for the information image to be captured by the image pickup section.

6. The electronic camera according to claim 5, further comprising:
an information analyzing section which performs image processing on the information image captured by the image pickup section to analyze the unique network information and the identification information of the information processing apparatus included in the unique network information; and
a command output section which sends a control command to the information processing apparatus via the access point using the wireless communication protocol based on the unique network information and the identification information of the information processing apparatus analyzed by the information analyzing section.

7. The electronic camera according to claim 5, wherein the image output section is one of a display monitor and a printer.

8. A method for controlling an information processing apparatus from an electronic camera, the method comprising:
allowing a user to select a control content for an information processing apparatus by manipulation or non-manipulation of an operation member of the electronic camera, information indicating the selection result of the control content being stored in a storage medium in the electronic camera;
allowing the user to image a code displayed on a display section of the information processing apparatus with the electronic camera, the code containing information for establishing communication; and
causing the electronic camera to analyze the code to acquire the information for establishing communication, establish wireless communication between the electronic camera and the information processing apparatus, and send the selection result of the control content stored in a storage medium to the information processing apparatus to control the information processing apparatus.
